(19) United States
(12) Patent Application Publication
(10) Pub. No.: US 2010/0316045 A1
(43) Pub. Date: Dec. 16, 2010

(54) Prioritising Messages in a Communications Network

(76) Inventors: Hubert Przybysz, Hagersten (SE); Stephen Terrill, Madrid (ES)

Correspondence Address: ERICSSON INC., 6300 LEGACY DRIVE, M/S EVR 1-C-11, PLANO, TX, 75024, US

(21) Appl. No.: 12/445,708

(22) PCT Filed: Oct. 16, 2006
(86) PCT No.: PCT/EP06/67445

§ 371 Date: Aug. 20, 2010

(30) Foreign Application Priority Data
Oct. 16, 2006 (JP) 2006-281983
Oct. 15, 2007 (JP) 2007-268431

(51) Int. Cl. H04L 12/66

(52) U.S. Cl. 370/352

(57) ABSTRACT

A method and communications network node for allocating a priority level to an Internet Protocol (IP) packet containing all or part of a Session Initiation Protocol (SIP) message. One or more characteristics of the SIP message are determined, and the characteristics are mapped to a Differentiated Services Code Point (DSCP) value. The DSCP value is then applied to the IP packet header.

### FIELD OF THE INVENTION

The present invention relates to prioritising messages in a communications network.

### BACKGROUND TO THE INVENTION

Differentiated Services (DiffServ, RFC 2474, RFC 2475) is a mechanism used in some IP transport networks to provide differentiated treatment of IP packets. DiffSery achieves “scalability by aggregating traffic classification state, which is conveyed by means of IP-layer packet marking using the DS field”. A Differentiated Services Code Point (DSCP) value is included in the header of the IP packet, which accords a priority to the IP packet. DiffServ-capable network routers read the DSCP value and forward the IP packet to the next node according to its priority. Network resources are allocated to traffic streams by service provisioning policies which govern how traffic is marked and conditioned upon entry to a DiffServ-capable network, and how that traffic is forwarded within that network. In this way, IP traffic can be prioritised depending on the requirements of the IP packet.

Session Initiation Protocol (SIP) messages are used to carry information over communications networks (see RFC 3261). SIP was originally developed for call/session management, and this remains its primary use. SIP is usually accorded a high priority in a communications network as call/session management is a time critical application. However, recent applications are now using SIP messages for communicating application information. For example, some presence applications use SIP signalling in this way. Presence applications can require a large amount of non-time critical signalling, especially if there are many users using the presence application. Different applications that use SIP messages have different characteristics and latency requirements. For example, it is not necessary for a SIP message relating to a presence application to traverse a network as quickly as, for example, a SIP INVITE message for a voice call. However, in current transport networks all SIP messages receive uniform treatment regardless of any special requirements of the application sending the SIP message.

SIP messages may be transported in the same transport bearer together with other types of traffic, for example real-time or non-real-time media that also have different characteristics requirements. As illustrated in FIG. 1, a problem arises where non-time critical SIP signalling traverses a network at the same time as time critical signalling, such as Real-time Transport Protocol (RTP) signalling. A SIP sender sends an IP packet containing a SIP message of low priority (for example, from a presence application), and another sender sends a non-SIP containing IP packet. As no priority is accorded to the SIP message, it receives the same treatment in the transport network as the higher priority SIP and non-SIP signalling. The presence of the lower priority SIP message may therefore adversely affect the higher priority SIP and non-SIP signalling.

The situation illustrated in FIG. 1 is particularly problematic in the example where the transport network is a cellular radio network and the SIP receiver is a terminal. In this case, with varying transport conditions and scarce resources, the lower priority messages may interfere with call establishment for the SIP receiver (and for other SIP receivers also sharing the same resources).

DiffSery operates at the IP transport layer level, whilst SIP signalling operates at the application layer level and is independent of the lower layer transport protocol.

### SUMMARY OF THE INVENTION

The inventors have realised that by mapping a characteristic of a SIP message to a DSCP value in the header of an IP packet containing all or part of the SIP message, a priority can be accorded to the IP packet containing all or part of the SIP message when traversing a network.

According to a first aspect of the present invention, there is provided a method of allocating a priority to an Internet Protocol packet containing all or part of a Session Initiation Protocol message in a communications network, the method comprising:

determining one or more characteristics of the Session Initiation Protocol message;

mapping the determined characteristic(s) to a Differentiated Services Code Point value; and

applying the mapped Differentiated Services Code Point value to the Internet Protocol packet header.

The determined characteristic may be an explicit priority indication of the SIP message, or alternatively the determined characteristic may be selected from a Session Initiation Protocol message method; a Uniform Resource Indicator of the message; an indication that the message is a response; content of a header of the message; and content of a body of the message.

Preferably, the method further comprises, before the step of determining one or more characteristics, receiving the Session Initiation Protocol message at a Session Initiation Protocol classifier. In this way, it is not necessary for the originator of the SIP message to classify the message.

It is preferred that a Differentiated Services Code Point value applied to a Session Initiation protocol message is distinct from Differentiated Services Code Point values applied to non-Session Initiation protocol messages.

According to a second aspect of the invention, there is provided a communications network node for allocating a priority to an IP packet containing all or part of a Session Initiation Protocol message, the node comprising:

determination means to determine one or more characteristics of the Session Initiation Protocol message;

mapping means to map the determined characteristic(s) to a Differentiated Services Code Point value; and

means to apply the mapped Differentiated Services Code Point value to the Internet Protocol packet header.

The characteristic may be an explicit priority indication of the SIP message, or alternatively the characteristic may be selected from a Session Initiation Protocol message method; a Uniform Resource Indicator of the message; an indication that the message is a response; content of a header of the message; and content of a body of the message.

Preferably, the node comprises receiving means to receive a Session Initiation Protocol message.

The communications network may be an IP Multimedia Subsystem network, and the node may be located at a Call Session Control Function.

According to a third aspect of the invention, there is provided a communications network node for sending a Session Initiation Protocol message, the node comprising:

means to include a packet forwarding priority indication in said message.

### BRIEF DESCRIPTION OF THE DRAWINGS

FIG. 1 illustrates schematically a prior art transport of SIP and non-SIP containing IP packets over a transport network;

FIG. 2 illustrates schematically the transport of all or part of a SIP message contained in an IP packet over a transport network, the IP packet having a DSCP value in its header;

FIG. 3 illustrates schematically the transport of a SIP containing IP packet via a SIP Classifier over a transport network; and

FIG. 4 illustrates schematically the transport of all or part of a SIP message contained in IP packets from a Presence Application Server and a Multimedia Telephony Application Server over an IP Multimedia Subsystem network.

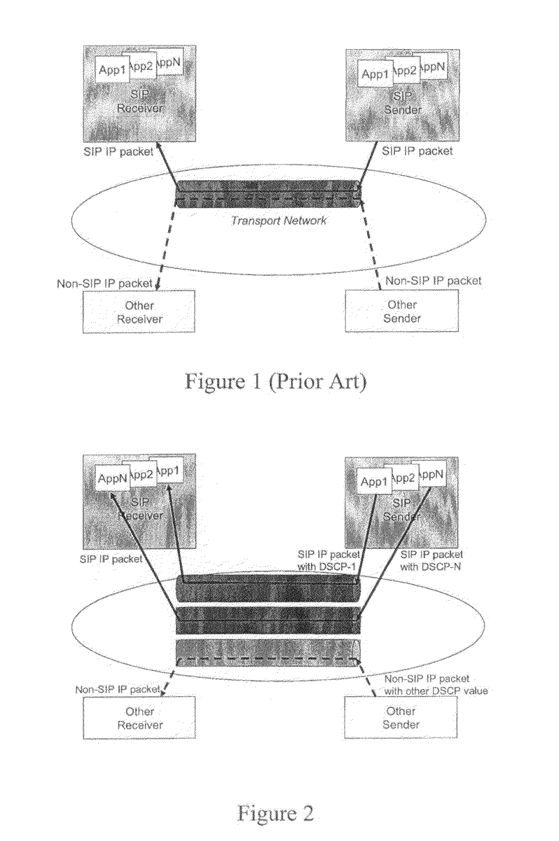

### DETAILED DESCRIPTION OF THE PREFERRED EMBODIMENTS

Referring to FIG. 2, there is shown a Differentiated Services (DiffServ) aware transport network. Whilst many users may be sending messages over this network, only two example senders are shown. A Session Initiation Protocol (SIP) sender sends SIP messages over the network, and a non-SIP sender sends non-SIP messages over the same network. The header of IP packets containing all or part of SIP messages is accorded a Differentiated Services Code Point (DSCP) value depending on the requirements of the sending SIP Application. It can be seen that the SIP sender may send messages from several different SIP applications, each of which may send SIP messages having different priority requirements. The headers of non-SIP containing IP packets may also be accorded DSCP values. The transport network uses the different DSCP values to apply different IP forwarding behaviour to the SIP containing IP packets and the non-SIP containing IP packets according to installed policies, thereby providing different IP packet delivery characteristics.

The same mechanism applies SIP messages having different priorities are sent over the network. For example, a SIP message from a SIP presence application would be accorded a lower priority than a SIP message from a Multimedia Telephony application, where the delivery of the message is time critical. In this case, the SIP messages are accorded different DSCP values relating to their priorities.

The DSCP values used may be specific to SIP messages, which allows the transport network to differentiate different SIP traffic types from non-SIP traffic.

In order to accord a DSCP value to the header of an IP packet containing all or part of a SIP message, the SIP message must be classified in some way. Classification is performed by a SIP classifier, which accords a DSCP value to the header of an IP packet containing all or part of a SIP message depending on the classification of the SIP message. Different methods can be used to classify a SIP message. For example, a first method is to analyse the SIP message, and a second method is to obtain an explicit priority indication from the SIP message. These two methods are described below:

### 1. SIP Message Analysis

When the SIP classifier receives a SIP message, it deduces the type of application from which the SIP message has been sent. The SIP classifier comprises a set of classification filters or rules that can map the type of SIP message to a DSCP value, and include the mapped DSCP value in the IP packet header containing all or part of the SIP message.

Examples of the types of SIP message characteristic that may be analysed by the SIP classifier in order to accord a DSCP value to a SIP containing IP packet header include any of the following:
SIP request method (e.g. INVITE method belongs to a call/session application, while MESSAGE belongs to a messaging application)
SIP Request-Uniform Resource Identifier (URI)
SIP response (typically the response will have the same DSCP value as the request it responds to, but other rules may be applied)
Content of any SIP header in the SIP message (e.g. an Event header containing “presence” indicates presence application)
Content of any SIP message body (e.g. PoC specific body indicates Push-to-talk application)

### 2. Explicit Priority Indication

As an alternative to the SIP classifying method based on analysis of the SIP message described above, an explicit indication of requested packet forwarding priority is generated by the SIP application or another SIP classifier and sent explicitly in either the header or the body of the SIP message. The SIP classifier analyses the explicit indication and maps the indication directly to an applicable DSCP value for inclusion in the SIP containing IP packet header. This requires an extension of RFC 4412 “Communications Resource Priority for the Session Initiation Protocol” that defines new resource priority syntax and semantics to request specific IP packet forwarding priority in the Resource-Priority SIP header.

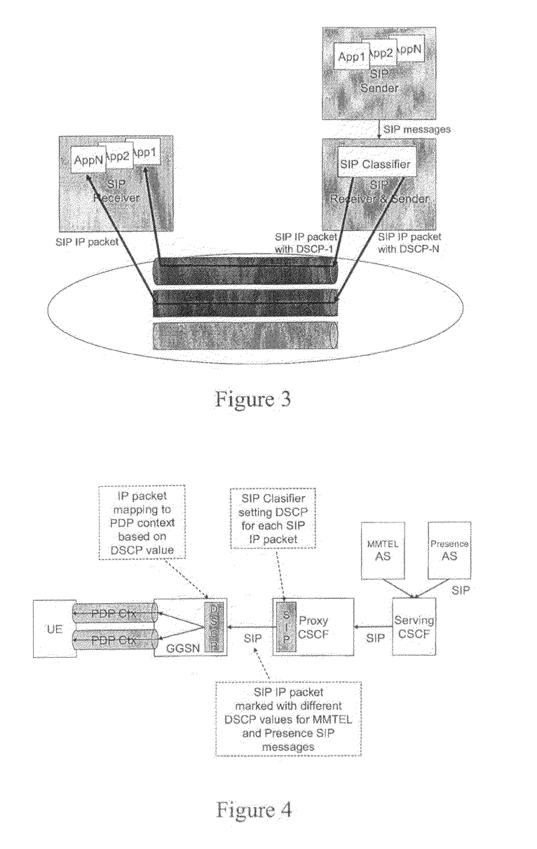

The SIP application that generates a SIP message need not itself comprise the classifier. In this case, the SIP message passes through a separate SIP classifier, as illustrated in FIG. 3. In an IP Multimedia Subsystem (IMS) network, the SIP classifier is typically located at a Proxy Call Session Control Function (P-CSCF), although any node that sends or forwards a SIP message could perform classification and accordingly apply a DSCP value to the header of an IP packet containing part or all of the SIP message.

An example of how the invention applies to 3GPP IMS and access networks is illustrated schematically in FIG. 4. Two SIP Application Servers are shown: a Multimedia Telephony Application Server (MMTEL AS) that requires fast SIP signalling, and a Presence Application Server (Presence AS) where fast delivery of SIP messages is not as important. The network further comprises a Serving Call Session Control Function (S-CSCF) that receives SIP messages and forwards them to a P-CSCF.

A SIP message sent from the MMTEL AS or the Presence AS to the S-CSCF is forwarded to the P-CSCF. The SIP message is classified at the P-CSCF, using one of the methods described above, to determine the relevant DSCP value for the IP packet in which the SIP message will be forwarded to the access network. A SIP message sent from the MMTEL AS will be accorded a DSCP value corresponding to higher forwarding priority while a SIP message sent from the Presence AS application will be accorded a DSCP corresponding to a lower forwarding priority.

In the case where the SIP message is classified by using SIP message analysis, the P-CSCF analyses the message and content of the incoming SIP message from the S-CSCF and sets the correct DSCP value depending on, for example, if the message is MMTEL or Presence related. In this simple example, analysing the SIP method is sufficient. The term method is used herein to refer to method of the SIP message, such as INVITE, REGISTER etc.

In the case where the SIP message is classified by including an explicit indication in the SIP message, the MMTEL AS sets in the SIP message header an indication of high forwarding priority, while the Presence AS would set a low forwarding priority indication. The SIP classifier maps the explicit indications to the correct DSCP values reflecting the requested forwarding priority.

The DSCP value is included in the IP packet header of the IP packet containing all or part of the SIP message. The IP packet is then forwarded across the network according to the DSCP value in its header. Different DSCP values allow a Gateway General Support Node (GGSN) to map the incoming IP packet to different quality Packet Data Protocol (PDP) contexts.

It is possible that both SIP and non-SIP signalling traversing a transport network would share the same transport priority, and therefore be accorded the same DSCP values in their IP packet headers. However, it may be desirable to ensure that other applications are not erroneously using the DSCP values utilised for the SIP signalling. This prevents non-SIP applications from using the priority forwarding accorded to SIP signalling, and may be achieved by providing nodes such as firewalls, which ensure that only “allowed” nodes can send IP packets with certain DSCP values. Alternatively, nodes within the transport network that perform the DSCP prioritisation (such as a GGSN) could police the packets to ensure that only the packets from “allowed” source IP address are prioritised.

It will be appreciated by persons skilled in the art that various modifications may be made to the embodiments described above without departing from the scope of the present invention. For example, the invention has been described with reference to IMS networks, although it could also be used in non-IMS networks that use SIP signalling. Furthermore, the invention has mostly been described in the context of reducing the priority of SIP messages from applications such as presence applications. However, the priority of a SIP message may be increased in some circumstances, for example when setting up an emergency call.

1. A method of allocating a priority to an Internet Protocol packet containing all or part of a Session Initiation Protocol message in a communications network, the method comprising:
determining one or more characteristics of the Session Initiation Protocol message;
mapping the determined characteristic(s) to a Differentiated Services Code Point value; and
applying the mapped Differentiated Services Code Point value to the Internet Protocol packet header.

2. A method according to claim 1, wherein said characteristic is an explicit priority indication of the SIP message.

3. A method according to claim 1, wherein said characteristic is a Session Initiation Protocol message method; a Uniform Resource Indicator of the message; an indication that the message is a response; content of a header of the message; and content of a body of the message.

4. A method according to any one of claim 1, 2 or 3, further comprising, before the step of determining one or more characteristics, receiving the Session Initiation Protocol message at a Session Initiation Protocol classifier.

5. A method according to any one of the preceding claims, wherein a Differentiated Services Code Point value applied to a Session Initiation protocol message is distinct from Differentiated Services Code Point values applied to non-Session Initiation protocol messages.

6. A communications network node for allocating a priority to an IP packet containing all or part of a Session Initiation Protocol message, the node comprising:
determination means to determine one or more characteristics of the Session Initiation Protocol message;
mapping means to map the determined characteristic(s) to a Differentiated Services Code Point value; and
means to apply the mapped Differentiated Services Code Point value to the Internet Protocol packet header.

7. A communications network node according to claim 6, wherein said characteristic is an explicit priority indication of the SIP message.

8. A communications network node according to claim 6, wherein said characteristic is a Session Initiation Protocol message method; a Uniform Resource Indicator of the message; an indication that the message is a response; content of a header of the message; and content of a body of the message.

9. A communications network node according to any one of claims 6, 7 and 8, comprising receiving means to receive a Session Initiation Protocol message.

10. A communications network node according to any one of claims 5 to 9, wherein the communications network is an IP Multimedia Subsystem network.

11. A communications network node according to any one of claims 5 to 10, wherein the node is located at a Call Session Control Function.

12. A communications network node for sending a Session Initiation Protocol message, the node comprising:
means to include a packet forwarding priority indication in said message.
